(19) United States
(12) Patent Application Publication
(10) Pub. No.: US 2021/0406817 A1
(43) Pub. Date: Dec. 30, 2021

(54) System and Method for Secure Delivery of Medical Cannabis Products

(71) Applicant: Najeebah Tanzil, Pontiac, MI (US)

(72) Inventor: Najeebah Tanzil, Pontiac, MI (US)

(21) Appl. No.: 17/038,012

(22) Filed: Sep. 30, 2020

Related U.S. Application Data
(60) Provisional application No. 63/043,615, filed on Jun. 24, 2020.

(51) Int. Cl. G06Q 10/08; H04W 4/80; G07C 9/00; G06Q 30/06

(52) U.S. Cl. CPC G06Q 10/0832; G06Q 10/0833; G06Q 30/0641; G07C 9/00912; H04W 4/80

(57) ABSTRACT

The present invention relates to a system and a related method for the secure ordering, tracking and delivery of a narcotic product (e.g., medicinal or recreational marijuana) to a remote location, such as a residence. More specifically, the secure lockbox functions in combination with a software application that enables the customer to order the product, track its real-time delivery, and expected arrival time for the order from a remote location. The lockbox is sealed with the ordered product inside, and can only be accessed by the customer with a unique and secretive code.

### CROSS-REFERENCE TO RELATED APPLICATION

The present application claims priority to and the benefit of U.S. Provisional Application No. 63/043,615 filed on Jun. 24, 2020, which is incorporated herein by reference in its entirety.

### BACKGROUND

The present invention relates generally to a system and related method for the secure delivery of medical products, and particularly Cannabis products. More specifically, the present invention relates to a secure delivery service and lockbox combination to deliver medical Cannabis and other similar products, which functions in coordination with a corresponding smartphone application. A user may order the required product to be delivered in a secure lockbox, and may then track the progress and real-time delivery status of said product by using the mobile software application. The lockbox is sealed with the ordered product inside, and is accessible to the user by entering a secret code into the lockbox. The ordering and delivery system and related method of the present invention allows users to obtain medical Cannabis product in a safe and secure manner, and without having to leave their homes. Accordingly, the present specification makes specific reference thereto. However, it is to be appreciated that aspects of the present invention are also equally applicable to other like applications, devices and methods of manufacture.

Currently, the use of medical marijuana has been legalized in over 33 U.S. states, and the use of marijuana for recreational use has been legalized in 11 states. Medical Cannabis, also known as medical marijuana or MMJ, refers to the use of Cannabis and its active constituent cannabinoids, such as Cannabidiol (CBD), as medical therapy to treat disease, certain medical conditions, and/or to alleviate symptoms. For example, medical Cannabis has been used to reduce the nausea and vomiting associated with chemotherapy and people receiving treatment for AIDS, and it is also useful for treating chronic pain, muscle spasticity, and anxiety. Additionally, medical marijuana has also been used to treat attention deficit disorders (ADHD/ADD), Alzheimer's disease, arthritis, Crohn's disease, epilepsy, migraine, headaches, post-traumatic stress disorder (PTSD) and other conditions or symptoms. Further, animal studies show that the cannabinoids found in marijuana may have analgesic and anti-inflammatory effects, antitumor effects, and anticancer effects, including the treatment of breast and lung cancer.

Unfortunately, the folks that can benefit the most from medical marijuana are not always able to go the pharmacy, supplier or Cannabis store to obtain the marijuana due to their illness or affliction. Other folks may lack a means of transportation to travel to and from the pharmacy, supplier or Cannabis store. In such instances, home delivery of the medical marijuana may be necessary. Unfortunately, the delivery of marijuana to a user for medicinal or recreational purposes presents its own set of challenges.

For example, because marijuana is a scheduled narcotic and has, at times, historically been tied to the criminal element, security of the product and the driver is of utmost concern. Additionally, there are also concerns with the driver having access to the product during its transport. For example, without a tamperproof delivery device or method, a driver could access the product and replace it with a benign substance having the same appearance, thereby denying the end user of the much needed benefits of the product.

Another problem associated with the delivery of medical or recreational Cannabis is that the customer cannot track the real-time status of the delivery person and product. More specifically, the customer has no knowledge of the real-time location of the package, nor does the customer have any idea if the package has been stolen and/or if the Cannabis is missing. Additionally, the delay in the delivery of medicinal Cannabis may lead to serious problems for the customer in need (e.g., lack of pain relief, nausea, etc.), not to mention potential civil and criminal liability against those involved in the theft or diversion of the package containing the medicinal or recreational Cannabis.

Therefore, there exists a long felt need in the art for a device and related method that allows for the secure delivery of medicinal and recreational marijuana, or any other valuable item that is at a heightened risk of being lost, stolen or tampered with, to a remote location, such as the user's home or place of business. There is also a long felt need in the art for a device and related method that enables a user to easily order and securely receive a medical product remotely, and without the need for the user to physically visit a pharmacy, store or dispensary. Additionally, there is a long felt need in the art for a device and a related method that provides the user or customer with the ability to easily track the status of the item to be delivered (e.g., Cannabis), and to obtain a precise window of time in which to expect to its delivery. Finally, there is a long felt need in the art for a device and related method that is relatively easy to use, and inexpensive to manufacture.

The subject matter disclosed and claimed herein, in one embodiment thereof, comprises a secure lockbox for delivering medicinal and recreational Cannabis products, and a convenient method for ordering and tracking the products throughout the delivery process, from origin to destination. The system of the present invention comprises a secure lockbox device having an unlocking mechanism, and a corresponding mobile software application and method. More specifically, the mobile software application may be used by the end user or customer to order a product and/or fulfill a prescription, and then track the real-time delivery of the product via an expected arrival predictor. The lockbox portion of the system is sealed with the ordered product safely secured therein, and may only be accessed by the customer and other authorized personnel with a secret and individualized code that triggers the unlocking mechanism. The comprehensive ordering and delivery system of the present invention allow medicinal and recreational Cannabis users to obtain Cannabis in its pure, unadulterated and prescribed form without having to leave their homes.

In this manner, the secure lockbox and related mobile application of the present invention accomplishes all of the forgoing objectives, and provides a relatively safe and secure medicinal and recreational Cannabis delivery system for users that may be incapable of visiting a store, a pharmacy or a dispensary. The secure lockbox of the present invention is tamperproof, and can be easily handled and transported to the desired location without incident. Additionally, the secure lockbox and related mobile application of the present invention provides users with the ability to continuously track the delivery of their order from its origination to its destination, and includes an expected arrival predictor.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a secure lockbox for delivering a prescribed narcotic product, such as medicinal Cannabis, and a convenient method for ordering and tracking the ordered narcotic product. The system comprises a Cannabis product ordering mechanism, and a secure lockbox for delivering the product safely to the customer at a remote location. The method employs a software application and/or smartphone application which may be utilized by a customer to order the narcotic product, and then track its delivery in real-time and with the ability to accurately predict its arrival. The lockbox is sealed with the ordered product inside, and can only be accessed by the customer or the dispensary using a secret code which is input into the system to instruct the lockbox to release its contents. The comprehensive ordering and delivery system of the present invention allows Cannabis users to obtain the ordered medicinal or recreational Cannabis product without having to leave the safety and security of their homes.

The secured lockbox of the present invention also provides the customer and the dispensary with confirmation that the customer is getting exactly what they paid for as neither the delivery personnel, nor anyone else involved in the delivery process will have access to the contents of the secured lockbox or the security code. More specifically, only the dispensary and the customer will be able to gain access to the product within the secured lockbox via the individualized code. The dispensary or other authorized service provider will program the code for the customer, and will notify the customer of the code before arrival of the secured lockbox and product through the smartphone application. Once the delivery personnel arrives, the customer will type in the security code to gain access to the product held in the lockbox. The customer can then return the empty lockbox to the delivery person.

In one embodiment of the present invention, it is very convenient for a customer to place a remote order for, track and receive a Cannabis product using the smartphone application of the present invention. The invention further includes a lockbox security system having an input keypad for entering a secret code, and a display for displaying the entered code. In this particular embodiment, the secure lockbox is a generally rectangular shaped box having an interior space for keeping the Cannabis product safe for delivery to the customer. When the delivery personnel reaches the drop off or delivery location, the customer will enter a unique security code provided by the dispensary using the keypad, which gets displayed on the display screen. The security code is programmed by the dispensary when the product is ready to ship and provided to the customer in a secure manner.

In another exemplary embodiment of the presently described invention, a secure lockbox may be provided that comprises a container with an access lid; an input means for receiving a secure code; a display screen for showing the entered secure code; a switch means enabling locking or unlocking of the lockbox; and a control unit or processor for communicating data between the input means and the switch and/or controlling the secure lockbox as well as the display where required. The secure code can be programmed into the container at the dispensary when the Cannabis product is inserted into the container, and then communicated to the customer in a secure manner so that the customer can access the Cannabis product within the container upon receipt of the secure lockbox.

In yet another exemplary embodiment of the presently described invention, a software application for remotely and securely ordering, tracking and receiving a narcotic product, such as medicinal or recreational Cannabis, is disclosed. The method of remotely ordering, tracking and receiving the narcotic product includes the steps of: (a) initially browsing a list of available narcotic products via a mobile application; (b) selecting a narcotic product from the list of available narcotic products; (c) ordering the selected narcotic product; (d) receiving a security code from the dispensary of the narcotic product via the mobile application; (e) tracking the delivery of the narcotic product using the security code and the mobile application; and (f) receiving the narcotic product in a secure lockbox which is only accessible by inputting the security code therein.

In yet a further exemplary embodiment of the presently described invention, a method for accessing a medical Cannabis product sealed in a secure lockbox is disclosed. The method comprises the steps of initially ordering the medical Cannabis product from a dispensary using a smartphone application or a website. Next, the system generates a secure code programmed by the dispensary at a client device. The received secure code is entered through an input means located on the secure lockbox such as by a key pad or an NFC device. The device compares the entered secure code with the secure code programmed by the dispensary, which determines whether the code entered is the correct code. Then access to the secure lockbox is granted upon a successful match of the entered secure code with the programmed secure code. In the case of a mismatch, the user is then asked to re-enter the secure code and is only permitted a limited number of attempts to enter the code prior to the lockbox being disabled.

In another embodiment of the presently described invention, a system for secure ordering of medical marijuana products is described and includes a transportable lockbox that has sidewalls, a base, a lid, a lock, a display, a processor and a secure code receiving device. This embodiment includes a smart device for ordering marijuana products, and a server remote from each of the smart device and lockbox for processing information received from the smart device and a dispensary. The dispensary is capable of filling an order for medical marijuana, and the dispensary is wirelessly connected to both the smart device and lockbox via the server. A code is provided by the dispensary and transmitted to the lockbox and the customer's smart device.

In a still further embodiment of the presently described invention, a lockbox and medical marijuana combination is described and includes a transportable lockbox that has sidewalls, a base and a lid, wherein the lockbox further comprises a lock, a display, a processor, a battery and a code receiving device. The sidewalls, base and lid form an interior, and a package of medicinal or recreational marijuana may be placed within the interior of the lockbox. A code is then programmed into the code receiving device, and a lock for securing the medical marijuana within the interior of the lockbox is operable by the customer entering the code into the code receiving device upon receipt of the lockbox at a remote location.

To the accomplishment of the foregoing and related ends, certain illustrative aspects of the disclosed innovation is described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one possible embodiment of a secure lockbox of the present invention in accordance with the disclosed invention;

FIG. 2 illustrates a perspective view of one possible embodiment of a secure lockbox of the present invention, wherein a security code has been entered into the display area of the secure lockbox in accordance with the disclosed invention;

FIG. 3 illustrates a perspective view of one possible embodiment of a secure lockbox of the present invention in a partially opened position and containing a Cannabis product in accordance with the disclosed invention;

FIG. 4 illustrates a flow chart showing the steps of one potential embodiment of the method of safely ordering, tracking and receiving a Cannabis product of the present invention in accordance with the disclosed invention;

FIG. 5a illustrates one potential embodiment of a user interface of a software application used to manage and track an order delivered via the present invention in accordance with the disclosed invention, wherein the user interface identifies the customer and the delivery person;

FIG. 5b illustrates one potential embodiment of a user interface of a software application used to manage and track an order delivered via the present invention in accordance with the disclosed invention, wherein the user must input his or her credentials;

FIG. 5c illustrates one potential embodiment of a user interface of a software application used to manage and track an order delivered via the present invention in accordance with the disclosed invention, wherein the user can review and submit their order;

FIG. 6a illustrates one potential embodiment of a user interface of a software application used to manage and track an order delivered via the present invention in accordance with the disclosed invention, wherein the driver or delivery person is identified; and

FIG. 6b illustrates one potential embodiment of a user interface of a software application used to manage and track an order delivered via the present invention in accordance with the disclosed invention, wherein the driver's current location can be determined.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form in order to facilitate a description thereof.

As noted above, there exists a long felt need in the art for a device and related method that allows for the secure delivery of a narcotic product, or any other valuable item that is at a heightened risk of being lost, stolen or tampered with, to a remote location. There is also a long felt need in the art for a device and related method that enables a user to easily order, track, anticipate a specific delivery time, and securely receive a narcotic product remotely, and without the need for the user to physically visit a pharmacy, store or dispensary.

The innovative system of the present invention features a secure lockbox for delivering medicinal Cannabis and other narcotic products, and a convenient method for ordering, tracking and anticipating the delivery of the same. The disclosed lockbox employs a software application used by a customer to order the narcotics, and track real-time delivery and the expected arrival of the ordered products. The lockbox is sealed with the ordered product inside and is accessible only by the customer and/or the dispensary from which the order has been placed. More specifically, the lockbox is accessed with a secret code programmed by the dispensary, which is shared with the customer on successful ordering of the narcotic product. Alternatively, a secure NFC code can be read and communicated by the smartphone to unlock the lockbox. The narcotic ordering and delivery system of the present invention allows narcotic users to remotely order product and obtain the required product without having to leave the safety and convenience of their homes.

The secure lockbox of the present invention also ensures that the customer receives what he or she actually ordered and paid for, as the secure lockbox is not accessible to any other person, such as the delivery personnel or anyone else in the supply chain. Only the dispensary and the customer will be able to access the product inside the secure lockbox. More specifically, the dispensary programs or creates the secure code for the customer, and notifies the customer of the code before arrival of the secure lockbox through smartphone application. Alternatively, the secure code may be shared through an SMS, text, or an email. Once the delivery personnel arrives, the customer enters the received code or uses a secure NFC code to gain access to the product housed with the secured lockbox.

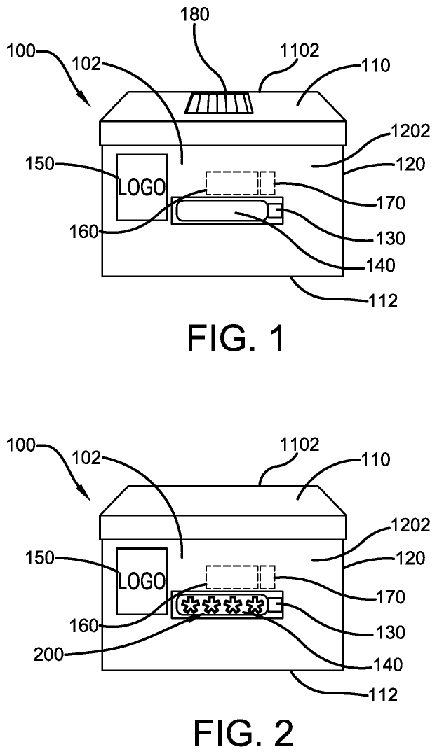

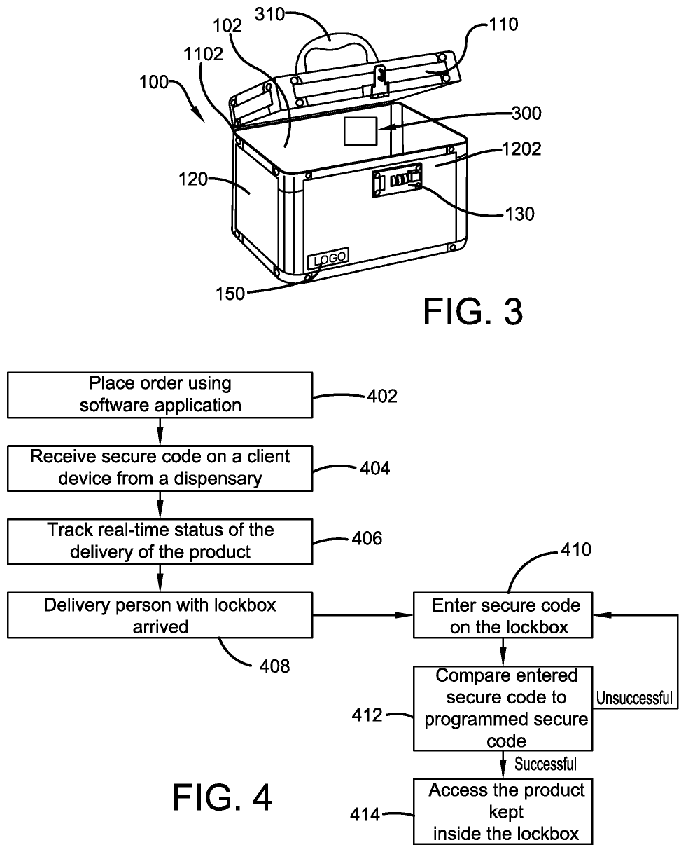

Referring initially to the drawings, FIG. 1 illustrates a perspective view of one possible embodiment of a secure lockbox 100 of the present invention in accordance with the disclosed architecture. The secure lockbox 100 of the present invention is a generally cuboidal shaped container having a housing 102 that makes up the body of the secured lockbox 100. The housing 102 provides an interior space to keep and store an item, such as medicinal or recreational Cannabis or other narcotic products, for delivering the same to a remote customer. The interior space may be waterproof and generally sealed to protect the contents from the elements and surrounding environment. The secure lockbox 100 structure includes preferably a plurality of side walls 120, a front wall 1202, a lockable lid 110, and a bottom panel 112. The lockable lid 110 forms the top surface of the secure lockbox 100, and enables a customer to open the lockbox 100 and access the medical Cannabis kept inside the lockbox 100. The lid 110 is preferably hinged along an edge 1102 that enables opening and closing of the access lid 110 relative to the front wall 1202. The lid 110 may further contain a handle, as best shown in FIG. 3, to enable the user to hold the secure lockbox 100, or to use the same open the lid 110.

As best shown in FIGS. 1 and 2, the secure lockbox 100 of the present invention further comprises a means for enabling access to the lockbox 100. More specifically, the front wall 1202 has an input interface 130 for entering or receiving a secret code or signal to open the lid 110, and thereby gain access to the interior of the lockbox 100. Further, the front wall 1202 has a readable display interface 140 for displaying a secret code entered by the customer using the input interface 130. The display may also provide other messages such as “error,” “locked,” or the like. The secret code entered using the input interface 130 may be displayed as exact characters or in a hidden or scrambled form on the display interface 140, as an enhanced security feature. The input interface 130 may be in the form of a keypad, a touch panel, or any other input means known in the art that enables a user to enter the secret code. In addition, the input interface 130 may be a receiver that is powered up by harvesting energy from the smartphone which transmits a code to the input interface 130, which then determines if the transmitted information or “token” is correct so that the lockbox may be opened.

The input interface 130 may also be a touch panel or a button-based interface, having a combination of letters, numerals, special characters, etc. The input and display settings may be programmed by the dispensary. The secret code for accessing the lockbox 100 is programmed by a dispensary in which a Cannabis order is placed, and is known only to the dispensary and the customer and only to the customer after receipt from the dispensary. More specifically, the dispensary preferably shares the secret code with the customer only after a successful Cannabis order has been placed, and before depositing of the Cannabis product. The secret code may be shared remotely with the customer by means of a software application, SMS, text, email, or any other known and suitable mechanism for the secure transmission of information.

The lockbox 100 may further comprise additional components, such as a control circuit 160, a switch 170, a wireless connection module, and a processor, for managing the secure delivery of the narcotic product to the customer. The lockbox 100 may also comprise a battery to support the display and the transmission of information if the lockbox 100 is not connected or connectable to an electrical source. The lockbox 100 may also have small solar panels 180 to provide power to the battery and/or the various components of the lockbox 100.

In a further embodiment of the present invention, the housing 102 of the lockbox 100 may comprise different sized shelves, containers or areas for holding different sized packages. The lockbox 100 may be suitably configured with appropriate electronics and telecommunications technology to allow the transmission of a signal to a software application running on a client device such as a smartphone, a computer, tablet and/or the like. The signal may indicate that the lid 110 has been opened, closed, or tampered with. More specifically, the internal portion of the housing 102 may include a suitable detector (e.g., pressure, light beam, weight, and/or the like) which may transmit a signal indicating that the delivery has occurred and/or that the lid 110 has been opened. The lockbox 100 may also have internal sensors that can detect when a package has been placed in the lockbox and when it has been removed from the lockbox 100.

As stated above, the lockbox 100 is of a generally cuboidal shape, but the lockbox 100 may also take the form of other geometric shapes. Additionally, the lockbox 100 may be made from a lightweight stainless steel, a hard plastic, other metals or metal alloys, or any other suitable and relatively impermeable material. The access lid 110 is preferably a top surface, however, other side walls 120 such as front wall 1202 may also be the access point used for accessing any item kept inside the lockbox 100, that is the lockbox could be side opening or even opened from its underside via the base. The lockbox 100 may be of any color, such as red, blue, black, green, etc., and may have a logo 150 of, for example, the Cannabis providing dispensary from which the product originated. Further, the lockbox 100 may have a design, graphics, text or other indicia printed on the side walls 120, top lid 110 or any other surface.

In another embodiment of the present invention, the secret code may be entered by a user by using, for example, a single rotating dial input interface which interacts with several discs or cams, a set of several rotating discs with inscribed symbols or numbers which directly interact with the locking mechanism, or through an electronic or mechanical keypad, as described above.

FIG. 2 illustrates a perspective view of one possible embodiment of the lockbox 100 of the present invention in accordance with the disclosed invention showing, and showing a security code 100 entered in the secure lockbox 100. More specifically, the lockbox 100 has an input interface 130 which is utilized by a customer to enter the secure code 200. A display screen 140 is also disposed on the front wall 1202 of the lockbox 100 for displaying the entered secure code 200. In a preferred embodiment, secure code 200 is between four to six characters in length, and is entered into the input interface 130 by depressing the corresponding numbers, symbols or letters on the keypad. Nonetheless, the length of secure code 200 is not limited and can be configured as per the settings of the dispensary and/or the configuration of the lockbox 100. The secure code 200 is preferably a one-time use code that utilized to release the product to the consumer after it has been delivered.

As the customer enters the secure code 200, or reads/transmits the NFC signal, the input interface 130 receives the entered secure code 200, and transmits the secure code 200 to a control circuit 160 of the lockbox 100. The control circuit or control unit 160 receives the secure code signal and compares the received secure code to a secure code programmed by the dispensary. More specifically, the lockbox 100 may be programmed with a secure code 200 by a dispensary before being shipped to the customer. The secure code is preferably programmed such that the code 200 is unique to each customer and to each order. For example, a randomly generated number or number and text combination can be used to program a secure code for each order. If a near field communication (NFC) device is used, the NFC device typically has a UID of 7 bytes in length, which is formed from a series of 0's and 1's.

As mentioned above, the control unit 160 compares the received secure code 200 to the programmed secure code, and sends the comparison result to a switch 170 attached to the lockbox 100. The switch 170 is in electrical communication with the control circuit 160, and is activated (i.e., repositionable) upon a successful match between the entered secure access code 200 and the secure code programmed by the dispensary. If the match is unsuccessful, the control circuit 160 may display a message such as “Wrong code, Re-enter secure code” or simply “Error” if, for example, the display is not large enough or does not have a rolling or scrolling function on the display interface 140 of the lockbox 100 to accommodate a longer message. Nonetheless, the length, type and configuration of the message is not restricted, and any other message signaling mechanism may be used to inform the customer that a wrong secure code has been entered.

In an exemplary embodiment of the present invention, the customer utilizes a smartphone application associated with the secured lockbox 100 to, for example, place an order for medicinal or recreational Cannabis from a dispensary. More specifically, the user opens the application and then browses, selects, and orders the required and/or prescribed product from a dispensary. Upon the successful ordering of the medical Cannabis product, the dispensary program sends a secure code to be used by the user to access the Cannabis when delivered to the user in the lockbox. The secure code is only known to the dispensary and the user, thereby preventing tampering of the lockbox 100 or stealing and replacing of the Cannabis. The programmed secure code is shared with the customer after the successful order is placed by the software application, SMS, text, email, or any other method. Once a delivery person reaches the user's destination, the user enters or transmits the security code 200 using either the keypad 130 or placing the smartphone near the keypad to transmit a signal to the NFC device, to access the Cannabis kept inside the lockbox 100.

FIG. 3 illustrates perspective view of another possible embodiment of a secured lockbox 100 of the present invention in a partially opened position, meaning that the lockable lid 110 is in a somewhat raised position relative to the front wall 1202. As previously mentioned, the secure lockbox 100 may further comprise a handle 310 positioned on the lid 110 for easy transportation of the lockbox 100, and to assist with the opening of the lid 110. The secure lockbox 100 may further comprise a control circuit and a switch (both as previously described) to control the secure delivery of a narcotic product 300, such as medicinal or recreational Cannabis. More specifically, the Cannabis product 300 is kept securely inside an interior space 102 of the lockbox 100, and is only accessible when the customer enters the correct security code provided by the dispensary.

The entered security code is received by the input interface 130, and is transmitted to the control circuit for further processing via a processor. The control circuit compares the entered or transmitted security code to a security code programmed by the dispensary, and sends the result signal to the switch. Upon a successful match, the switch allows the opening of the lid 110, thereby allowing the customer to access the Cannabis product 300 stored in the interior 102 of the lockbox 100. In the event of an unsuccessful match, the switch does not activate or permit the lockable lid 110 to be opened, and an error message is displayed. The user must then attempt to renter the security code and the process repeats itself. An unsuccessful match signal may be transmitted to the customer using a light emitting diode (LED), an audio alarm signal or any other method of signaling the errant security code. Further, after several unsuccessful attempts at opening the lockbox, the user will be locked out and will require the dispensary to issue a new security code to the user. If the authorized user is not the one attempting to enter the security code, then the police or other authorities can be alerted to the potential theft or tampering of the security lockbox 100 of the present invention.

FIG. 4 illustrates a flow chart showing the steps of one potential embodiment of the method of safely ordering, tracking and receiving a Cannabis product of the present invention in accordance with the disclosed invention. More specifically, at step 402, a user opens the software application of the present invention for ordering medical Cannabis on a smartphone or any other electronic device, and completes an order form. The order form may request the following non-exhaustive list of user details: name, address for delivery, phone number, prescribing physician, prescription information, the prescribed product, quantity, brand, dispensary, and other features of the product. At this step, the user can place the order using a web site or a web application as well. Upon receipt of a successful order, a pharmacist or other authorized individual of the dispensary packs the ordered quantity and product for delivery, and places the order inside a secured lockbox. The individual at the dispensary also assigns a unique code or codes to the lockbox. For example, there may be a first code for the delivery personnel to open the lockbox at the dispensary so that the product can be deposited therein (if the lockbox is provided by the user), and then a second discrete code for the user to open the lockbox after delivery of the product has been made, wherein the delivery person would not be provided with the second code.

At step 404, the user receives the assigned security code on the client device (e.g., a smartphone), wherein the security code is programmed and shared by the dispensary from which the order is placed. The security code may be shared through a software application, SMS, text, email, or any other remote data sharing mechanism. Next, at step 406, the software application includes features such as real-time tracking and/or status of the product being dispatched, shipped, in-route or on hold, or others, which can be utilized by the customer to track the delivery of the ordered medical Cannabis product. Step 406 is optional and can be used as per the preferences of the user/customer. At step 408, the delivery person arrives at a destination entered by the customer while ordering the product in step 402, along with the ordered Cannabis product contained in the secured lockbox 100. As previously stated, the lockbox 100 is secured and locked via a security code programmed by the dispensary before shipping the product to the customer. The security code is programmed such that the code is unique to each customer and each order. For example, a randomly generated number can be used to program a secure access code for each order or customer. Further, the security code can be of any number of digits, such as a 3-digit code, a 4-digit code, a 6-digit code, or any other length, as per the settings of the dispensary and the configuration and locking mechanism of the lockbox 100.

At step 410, the customer enters or transmits the security code through an input interface on the lockbox 100. At step 412, the inputted security code is received by a control circuit disposed on the lockbox 100, and is compared to the programmed security code of the lockbox 100 via a processor. If the codes match, at step 414, the lockable lid of the lockbox 100 is permitted to open, and the user/customer gains access to the ordered Cannabis product. However, if the codes do not match, the process returns to step 410 so that the user can re-enter the code and the comparison at step 412 follows as described above.

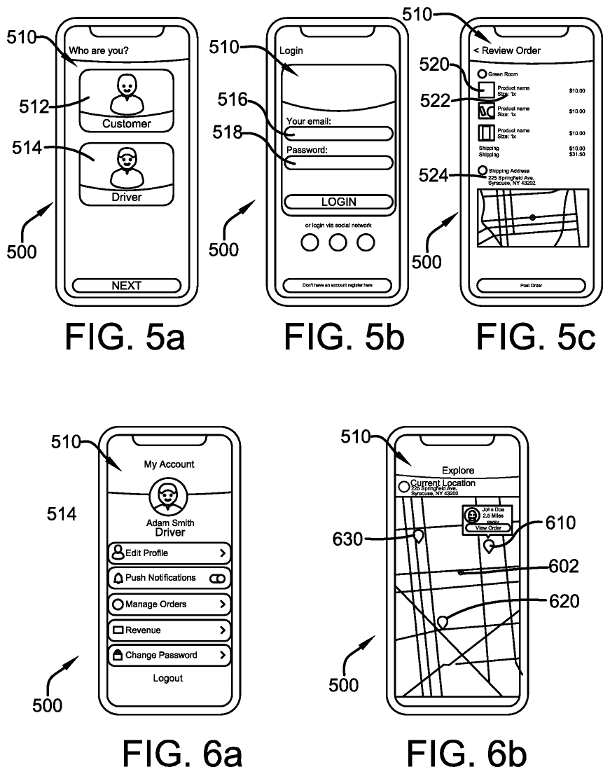

FIG. 5 generally discloses one potential embodiment of a user interface 510 of a software application that can be used to order, manage and track a narcotic or other product to be delivered in the secured lockbox 100 of the present invention in accordance with the disclosed architecture. More specifically, FIG. 5a illustrates one potential embodiment of the user interface 510 of the software application installed on a user's smartphone 500, which shows that the software application can be used by both the customer and a delivery person or driver. While creating an account or logging in, the user designates whether he or she is a customer 512 or a driver 514, and the user interface 510 is modified accordingly based on a profile selected by the user.

FIG. 5b illustrates one potential embodiment of a user interface 510 for providing log in information to gain access to different features of the software application of the present invention. The user, whether a customer 512 or a delivery person 514, may log into the application by entering login credentials, such as a User ID 516, an email ID, a phone number or user name that identifies the user, and enters a password 518. The entered user ID 516 and the password 518 is then sent wirelessly to servers remote from the lockbox 100 for verification. Alternatively, the customer 512 can login to the smartphone application using a social network application, such as Facebook®, Twitter®, Google® or other platform. Upon login, through the social or other network application, the smartphone application of the present invention retrieves the social and personal information of the user to be used for authentication and delivery of the ordered narcotic product.

FIG. 5c illustrates one potential embodiment of a user interface 510 of a customer 512, wherein the customer 512 may review a product 520 and the quantity 522 selected while ordering. The user interface 510 also shows the total amount to be paid for the order, and the customer 512 may check the destination entered for delivery before placing the order, and use a credit card or banking information to pay for the ordered product.

FIG. 6 generally illustrates a user interface of a software application for a driver delivering the ordered product in the secured lockbox 100 of the present invention in accordance with the disclosed architecture. More specifically, FIG. 6a discloses a user interface depicting a driver's profile 514. The user interface may allow the driver 514 to enable push notifications, edit his or her profile, manage orders for delivery, check revenue, change password(s), etc. FIG. 6b illustrates one potential embodiment of a user interface that shows a real-time navigational view of the delivery route, which can be utilized to track the distance to different users such as a first user 610, a second user 620 or a third user 630. A real-time location 602 of the driver 514 is also visible on the user interface. The driver's real-time location 602 can also be viewed by the customer 610, 620 and/or 630 using the software application. The customers 610, 620 and/or 630 may access their software application and can track the driver 514 in real-time.

In one embodiment of the present invention, the customer 512 may select a time slot for receiving the delivery while ordering the product using the software application. The payment for the order may also be done at the time of placing the order through the online gateway, for example, by entering a credit card number or other means of payment into a telephone keypad, voice commands, stored card information or computer keyboard. The smartphone application can also be used to provide feedback relative to quality of the product and/or the delivery service. For example, the customer 512 can leave a review about the overall experience of the delivery service. Further, the customer 512 may give a rating, review, or a tip to the delivery person 514 using the software application.

In a further embodiment of the present invention, the software application further comprises a notification management system, which is capable of notifying the customer and the driver of various events. For example, the driver may receive real-time notifications regarding the requests of the customers, pick up alerts or any other relevant notifications; while the customer may receive notifications or alerts related to successful order placement, order processing, order shipment, security code retrieval, when the driver arrives at the location, or any other notification which may be relevant for the customer.

The lockbox 100 may be marketed as a standalone product which can be utilized by various dispensaries, stores, etc. for delivering the product securely to their customers. The lockbox can also be purchased by the user, or the customer may receive a credit for the return of the lockbox to the dispensary.

Notwithstanding, the system and method of the present invention is not limited to narcotics (i.e., medicinal and recreational marijuana), and is also applicable for the delivery and traceability of other types of products that require secure delivery or tracking. The lockbox 100 and the software application can be configured as per the needs and requirements of the user. A wide variety of operable locking devices including a locking device and switch means may be used by one skilled in the art, such as, mechanical, magnetic, electrical, optical, etc.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “Cannabis”, “medicinal Cannabis” and “marijuana” are interchangeable and refer to a psychoactive drug from the Cannabis plant used primarily for medical or recreational purposes. Also, the terms “lockbox”, “secure lockbox” and “secured lockbox” are interchangeable and refer to a lockbox 100 which is used to secure the medical Cannabis product and deliver the product to the customer.

Notwithstanding the forgoing, the secured lockbox 100 of the present invention and its various structural components can be any suitable size, shape, color, style and configuration as is known in the art without affecting the overall concept of the invention, provided that it accomplishes the above stated objectives. One of ordinary skill in the art will appreciate that the shape and size of the secured lockbox 100 and its various components, as show in the FIGS. are for illustrative purposes only, and that many other shapes and sizes of the secured lockbox 100 are well within the scope of the present disclosure. Although dimensions of the secured lockbox 100 and its components (i.e., length, width, and height) are important design parameters for good performance, the secured lockbox 100 and its components may be any shape, size, color and style that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for secure ordering and delivery of a narcotic product comprising;
a lockbox having a plurality of sidewalls, a base, a lid, a lock, a display, a processor and a code receiving device, wherein the lockbox is transportable;
a smart device for ordering and tracking the narcotic product;
a server remote from each of the smart device and the lockbox for processing the order received from the smart device;
a dispensary for filling the order for the narcotic product, the dispensary being in communication with each of the smart device and the lockbox via the server; and
a code provided by the dispensary and wirelessly transmitted to the lockbox and the smart device.

2. The system for secure ordering and delivery of a narcotic product of claim 1, wherein the processor compares the code provided by the dispensary and entered by the smart device.

3. The system for secure ordering and delivery of a narcotic product of claim 1, wherein the lockbox is further comprised of a handle and one of a logo, a trademark, an emblem or the like of the dispensary.

4. The system for secure ordering and delivery of a narcotic product of claim 1, wherein the smart device includes a downloaded application for ordering the narcotic product.

5. The system for secure ordering and delivery of a narcotic product of claim 1, wherein the code receiving device comprises a keypad having at least one of a letter, a number, or a symbol.

6. The system for secure ordering and delivery of a narcotic product of claim 1, wherein the code receiving device is NFC enabled.

7. The system for secure ordering and delivery of a narcotic product of claim 1, wherein the display shows a message about the code when entered.

8. The system for secure ordering and delivery of a narcotic product of claim 1, wherein the smart device uses a social media application for ordering the narcotic product.

9. The system for secure ordering and delivery of a narcotic product of claim 1, wherein the lockbox further comprises at least one sensor and a compartment for holding the narcotic product.

10. The system for secure ordering and delivery of a narcotic product of claim 1, wherein the lockbox further comprises a battery.

11. A method for secure ordering and delivery of a narcotic product comprising the steps of:
ordering a the narcotic product from a dispensary using a smart device application;
providing a lockbox;
placing the narcotic product in the lockbox at the dispensary;
generating a security code programmed by the dispensary for the smart device and the lockbox;
entering a code on an input device located on the lockbox;
comparing the entered code with the security code programmed by the dispensary;
confirming the entered code matches the security code;
granting access to the lockbox only if the entered code matches the security code; and
retrieving the narcotic product from the lockbox.

12. The method of claim 11, including an additional step of transmitting the security code from a server to the lockbox after receipt of the security code from the dispensary after the step of generating the security code.

13. The method of claim 12, wherein the server is remote from each of the lockbox, the dispensary and the smart device.

14. The method of claim 11, wherein the step of entering the code on an input device is via one of a keypad, a rotating dial or a near field communication.

15. The method of claim 11, wherein the keypad includes at least one of a letter, a number, and a symbol.

16. The method of claim 11, wherein the smart device accesses the smart device application via a website.

17. The method of claim 11 further comprising the additional step of delivering the lockbox and the narcotic product together after the step of placing the narcotic product in the lockbox.

18. The method of claim 11 further comprising the additional step of initially browsing and then selecting the narcotic product prior to the step of ordering the narcotic product.

19. A lockbox and medical marijuana combination comprising:
a transportable lockbox having a plurality of sidewalls, a base, a lid, a lock, a display, a processor, a battery and a code receiving device; wherein the plurality of sidewalls, the base and the lid form an interior space;
a package of medical marijuana placed within the interior space of the lockbox;
a code programmed into the code receiving device; and
a lock for securing the medical marijuana within the interior space of the lockbox.

20. The lockbox and medical marijuana combination of claim 19, wherein the lockbox may be returned for a credit.
